(19) United States
(12) Patent Application Publication
(10) Pub. No.: US 2013/0107373 A1
(43) Pub. Date: May 2, 2013

(54) METHOD FOR MANUFACTURING LENS, LENS AND OPTICAL DEVICE

(71) Applicant: SANYO Electric Co., Ltd., Moriguchi-shi (JP)

(72) Inventor: Ai TAKUMI, Saitama-shi (JP)

(73) Assignee: SANYO ELECTRIC CO., LTD., Moriguchi-shi (JP)

(21) Appl. No.: 13/663,445

(22) Filed: Oct. 29, 2012

(30) Foreign Application Priority Data
Oct. 31, 2011 (JP) 2011-239171

(51) Int. Cl. B26D 3/00; G02B 3/00

(52) U.S. Cl. 359/642; 83/13

(57) ABSTRACT

A lens manufacturing method for manufacturing a lens including a lens portion having a circular shape and an end portion formed on the periphery of the lens portion by injection molding includes a cutting-off step of cutting off a gate portion from a lens intermediate body, the gate portion corresponding to a resin injection channel and being formed on a side surface of the end portion. In this arrangement, the cutting-off step includes a step of removing the gate portion in such a manner that a cutting plane is inclined with respect to the optical axis of the lens portion.

This application claims priority under 35 U.S.C. Section 119 of Japanese Patent Application No. 2011-239171 filed Oct. 31, 2011, entitled “METHOD FOR MANUFACTURING LENS, LENS AND OPTICAL DEVICE”. The disclosure of the above application is incorporated herein by reference.

### BACKGROUND OF THE INVENTION

1. Field of the Invention

The present invention relates to a method for manufacturing a lens, a lens and an optical device, and more particularly to an arrangement for use in forming a lens by injection molding.

2. Disclosure or Related Art

In recent years, a lens made of resin has been loaded in an optical device such as an optical pickup device or a camera module. Such a resin lens is formed by e.g. injection molding. In this arrangement, a lens which has been taken out of an injection molding die has a portion (hereinafter, called as a “gate portion”) corresponding to an inlet through which resin is supplied for injection molding. After the lens is taken out of the die, the gate portion is removed from the lens.

It is frequently required to form a lens devoid of a gate portion into a substantially circular shape. The reason for the requirement for forming a lens into a substantially circular shape is as follows.

In the case of an optical pickup device, for instance, use of a circular lens is advantageous in increasing the lens rotation amount and finely adjusting the lens position at the time of mounting a lens, as compared with a rectangular lens. Further, since the above arrangement makes it possible to adhesively mount a lens on a holder H at a position away from a lens portion by a distance L1, there is no likelihood that the adhesive will flow and smear the lens surface. On the other hand, for instance, in the case where a lens does not have a circular shape by e.g. cutting away apart of a circular portion, as shown in FIG. 14, the lens may have a portion where the distance between the lens surface and the outer perimeter of the lens is L2, which is shorter than L1. If the distance between the lens surface and the outer perimeter of the lens is the distance L1, it is possible to prevent intrusion of adhesive. However, if the distance is only the distance L2, the adhesive may flow and smear the lens surface.

In the case of a camera module, as shown in FIG. 15A and FIG. 15B, a lens is pressingly inserted in a barrel (housing member) of a lens module, which is a main component of the camera module. As shown in FIG. 15C, in the case where a portion (hereinafter, also called as a cutaway portion of a lens) as indicated by a range L3, which is a cutaway portion of a lens other than a D-shaped portion formed by cutting a circular portion of the lens into a D-shape, is large; and the circular portion of the lens is relatively small, in other words, in the case where the lens does no longer have a circular shape, it is difficult to uniformly exert a pressure to the inner wall of the barrel in pressingly inserting the lens in the barrel. As a result, decentering, distortion or deformation of the lens module is intolerable, which may degrade the performance of the lens module. In contrast, as shown in FIG. 15D, in the case where a cutaway portion as indicated by a range L4 which is a cutaway portion of a lens other than a D-shaped portion is small, and the circular portion of the lens is relatively large, in other words, in the case where the lens has a shape analogous to a circular shape, a pressure is substantially uniformly exerted on the inner wall of the barrel in pressingly inserting the lens in the barrel. This is advantageous in suppressing decentering, distortion or deformation of the lens module, and contributes to improvement of the performance of the lens module.

In view of the above, the following method has been currently performed as a method for cutting off a gate portion.

In the case where a gate portion is formed on a surface of a circular lens, there may be used a method for cutting off the gate portion along the outer surface of the circular lens. However, this method requires a high skill, and the cost may increase.

As a method for easily cutting off a gate portion, there is proposed a method for forming a D-shaped portion in advance at a position near the gate portion. In this arrangement, the D-shaped portion is retracted from the outline of a circle that defines the outer perimeter of a lens. Accordingly, it is relatively easy to cut off the gate portion in such a manner that a cut end does not deviate from the outline of the circle.

However, in the case where a D-shaped portion is formed in a lens, it is necessary to set the effective diameter of the lens at an inner position with respect to the D-shaped portion. Accordingly, it is necessary to set the effective diameter of the lens to a smaller value than the distance from the center of the lens to the perimeter of the D-shaped portion. Setting the effective diameter of a lens to a small value, however, may reduce the amount of light transmission, and may considerably degrade the lens performance. Conversely, setting the effective diameter of a lens to a large value may result in an increase in the diameter (distance) to the outer perimeter of the lens in order to form a D-shaped portion. As a result, the lens outer diameter may increase, and the cost required for the lens may increase. This is against the demand for miniaturization of a device or a module.

### SUMMARY OF THE INVENTION

A first aspect of the invention relates to a lens manufacturing method for manufacturing a lens by injection molding, the lens including a lens portion having a circular shape, and an end portion formed on a periphery of the lens portion. The lens manufacturing method according to the first aspect includes a cutting-off step of cutting off a gate portion from a lens intermediate body, the gate portion corresponding to a resin injection channel and being formed on a side surface of the end portion. The cutting-off step includes a step of removing the gate portion in such a manner that a cutting plane is inclined with respect to an optical axis of the lens portion.

In the first aspect, the lens intermediate body may have a first lens surface on one side thereof with respect to a direction of the optical axis, and a second lens surface on the other side thereof with respect to the direction of the optical axis, and an effective diameter of the first lens surface may be set smaller than an effective diameter of the second lens surface. Further, in the cutting-off step, the gate portion may be cut off in such a manner that an upper end of the cutting plane is close to the optical axis and that a lower end of the cutting plane is away from the optical axis, and the upper end of the cutting plane may be located on the one side, and the lower end of the cutting plane may be located on the other side.

In the above arrangement, in the cutting-off step, the gate portion may be cut off in such a manner that the lower end of the cutting plane is close to a connection position between the gate portion and the end portion.

A second aspect of the invention relates to a lens to be formed by cutting off a gate portion from a lens intermediate body formed by injection molding, the gate portion being formed on a side surface of an end portion. The lens according to the second aspect includes a lens portion having a circular shape, and the end portion formed on a periphery of the lens portion. In this arrangement, the lens is configured in such a manner that a cutting plane along which the gate portion is cut off is configured to incline with respect to an optical axis of the lens portion.

In the second aspect, the lens portion may have a first lens surface on one side thereof with respect to a direction of the optical axis, and a second lens surface on the other side thereof with respect to the direction of the optical axis, and an effective diameter of the first lens surface may be set smaller than an effective diameter of the second lens surface. Further, the cutting plane may be configured in such a manner that an upper end of the cutting plane is close to the optical axis and that a lower end of the cutting plane is away from the optical axis, and the upper end of the cutting plane may be located on the one side, and the lower end of the cutting plane may be located on the other side.

In the above arrangement, the cutting plane may be configured in such a manner that the lower end of the cutting plane is close to a connection position between the gate portion and the end portion.

A third aspect of the invention relates to an optical device. The optical device according to the third aspect includes the lens according to the second aspect, and a control system which controls an image to be formed by a light beam passing through the lens.

### BRIEF DESCRIPTION OF THE DRAWINGS

These and other objects, and novel features of the present invention will become more apparent upon reading the following detailed description of the embodiment along with the accompanying drawings.

FIG. 1 is a diagram showing an arrangement of a lens intermediate body according to an embodiment.

FIG. 2 is a diagram showing a flow of a process of manufacturing objective lenses according to the embodiment.

FIGS. 3A through 3C are diagrams showing an arrangement of an objective lens in a first embodiment.

FIGS. 4A through 4C are diagrams showing a comparative example of a method for cutting off a gate portion from an objective lens in the first embodiment.

FIGS. 5A through 5D are diagrams showing a method for cutting off a gate portion from an objective lens in the first embodiment.

FIG. 6 is a diagram showing a manner as to how burrs are generated in cutting off a gate portion from an objective lens by the method in the first embodiment.

FIGS. 7A through 7D are diagrams showing an arrangement of an objective lens in a second embodiment.

FIGS. 8A through 8D are diagrams showing a method for cutting off a gate portion from an objective lens in the second embodiment.

FIGS. 9A through 9C are diagrams showing a method for cutting off a gate portion from an objective lens in a first modification.

FIGS. 10A and 10B are diagrams showing an arrangement of an optical pickup device according to the embodiment.

FIG. 11 is a diagram showing an arrangement of a camera module according to the embodiment.

FIGS. 12A and 12B are diagrams showing a method for cutting off a gate portion from an objective lens in a second modification.

FIGS. 13A and 13B are diagrams showing a method for cutting off a gate portion from an objective lens in a third modification.

FIG. 14 is a diagram for describing a related art regarding mounting a lens on a holder.

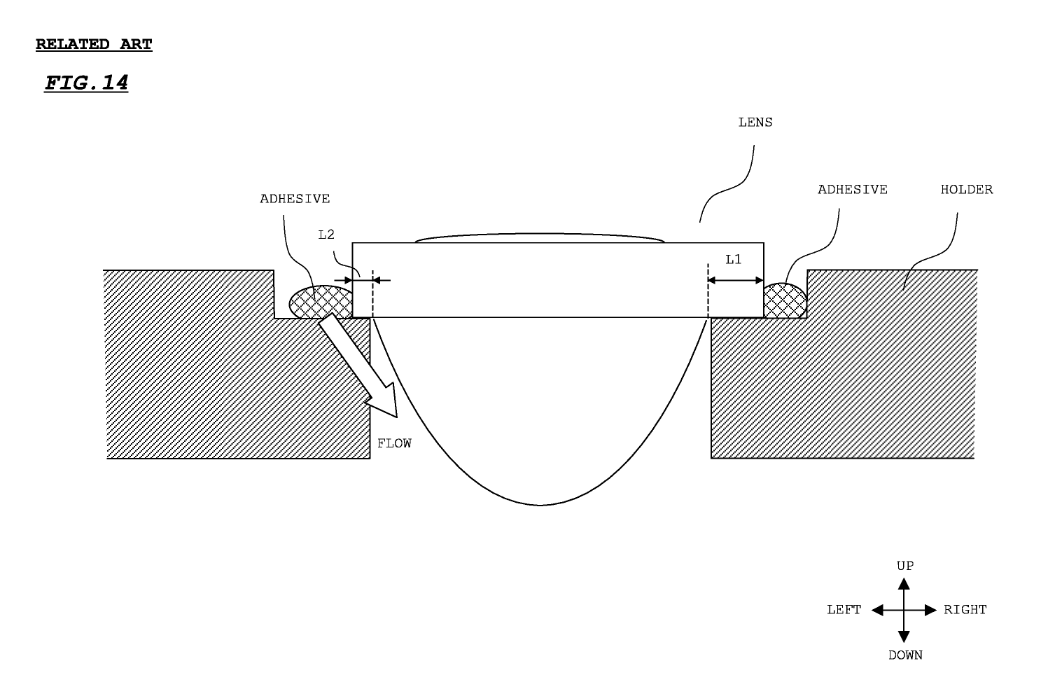

FIGS. 15A through 15D are diagrams for describing a related art regarding mounting a lens on a barrel.

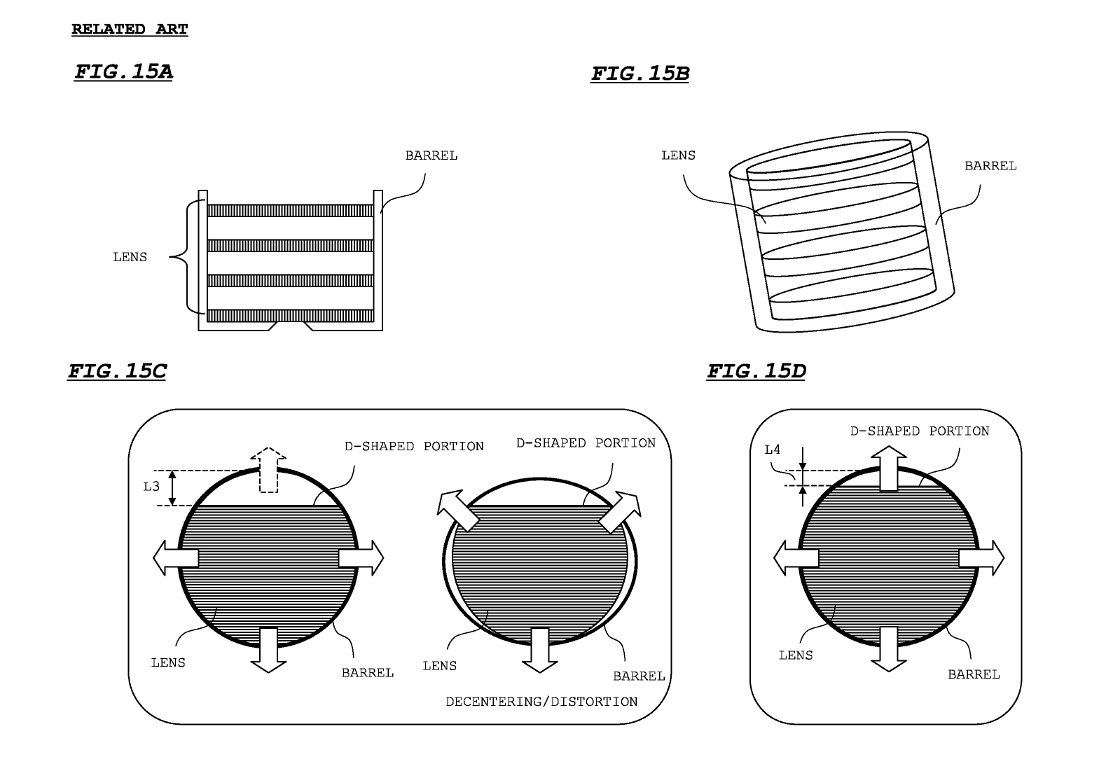

The drawings are provided mainly for describing the present invention, and do not limit the scope of the present invention.

### DESCRIPTION OF PREFERRED EMBODIMENTS

In the following, embodiments of the invention are described referring to the drawings.

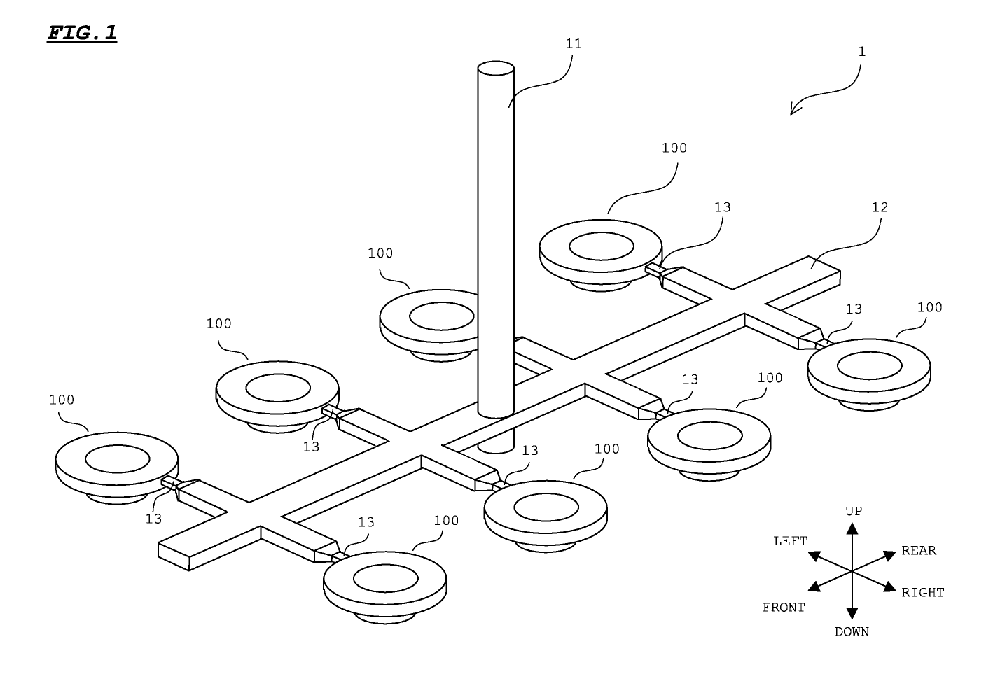

FIG. 1 is a perspective view schematically showing an example of a lens intermediate body 1 formed by injection molding. FIG. 1 shows a state that the lens intermediate body 1 is taken out of a die.

The lens intermediate body 1 is a resin molded member formed by injection molding. The lens intermediate body 1 has a spool portion 11, a runner portion 12, a plurality of gate portions 13, and a plurality of objective lenses 100.

The spool portion 11 has a rod-like shape and extends in up and down directions. The runner portion 12 has a rod-like shape and has branched portions extending in front and rear directions and in left and right directions. The gate portions 13 connect between the objective lenses 100 and the runner portion 12. The gate portion 13 has a smaller size than that of the runner portion 12 in front and rear directions and in up and down directions.

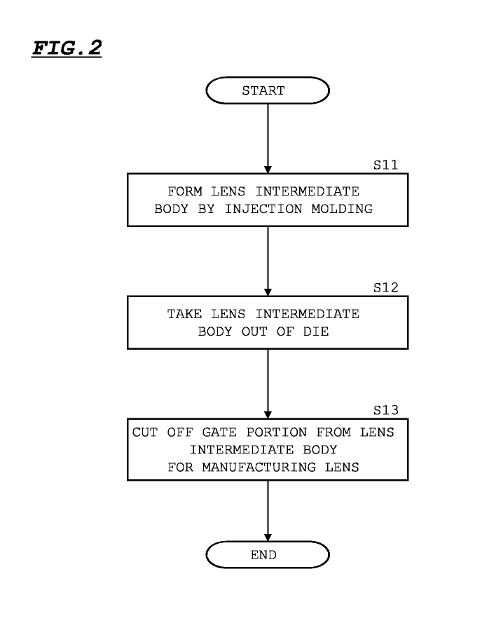

FIG. 2 is a diagram showing a flow of a process of manufacturing the objective lenses 100.

Firstly, the lens intermediate body 1 shown in FIG. 1 is formed by an injection molding die (S11). Specifically, melted resin is injected to a die groove corresponding to the spool portion 11. Thereafter, the resin is allowed to flow through a die groove corresponding to the runner portion 12, and then is injected to die grooves corresponding to the objective lenses 100 via the die groove corresponding to each gate portion 13. Then, the resin is cured by cooling the injected resin and the die, whereby the lens intermediate body 1 is molded. Then, the molded lens intermediate body 1 is taken out of the die (S12). Thereafter, the objective lenses 100 are manufactured by cutting off the gate portions 13 from the molded lens intermediate body 1 (S13).

As described above, the objective lenses 100 are obtained by cutting off the gate portions 13 from the molded lens intermediate body 1. In the following, there is described a method for manufacturing the objective lenses 100 by cutting off the gate portions 13 from the lens intermediate body 1.

### First Embodiment

In the first embodiment, an objective lens 100 corresponds to a “lens” in the claims. Lens surfaces 102 and 103 correspond to a “lens portion” in the claims. The lens surface 102 corresponds to a “first lens surface” in the claims. The lens surface 103 corresponds to a “second lens surface” in the claims. A contact point Pg2 corresponds to a “connection position” in the claims. The description regarding the correspondence between the claims and the first embodiment is merely an example, and the claims are not limited by the description of the first embodiment.

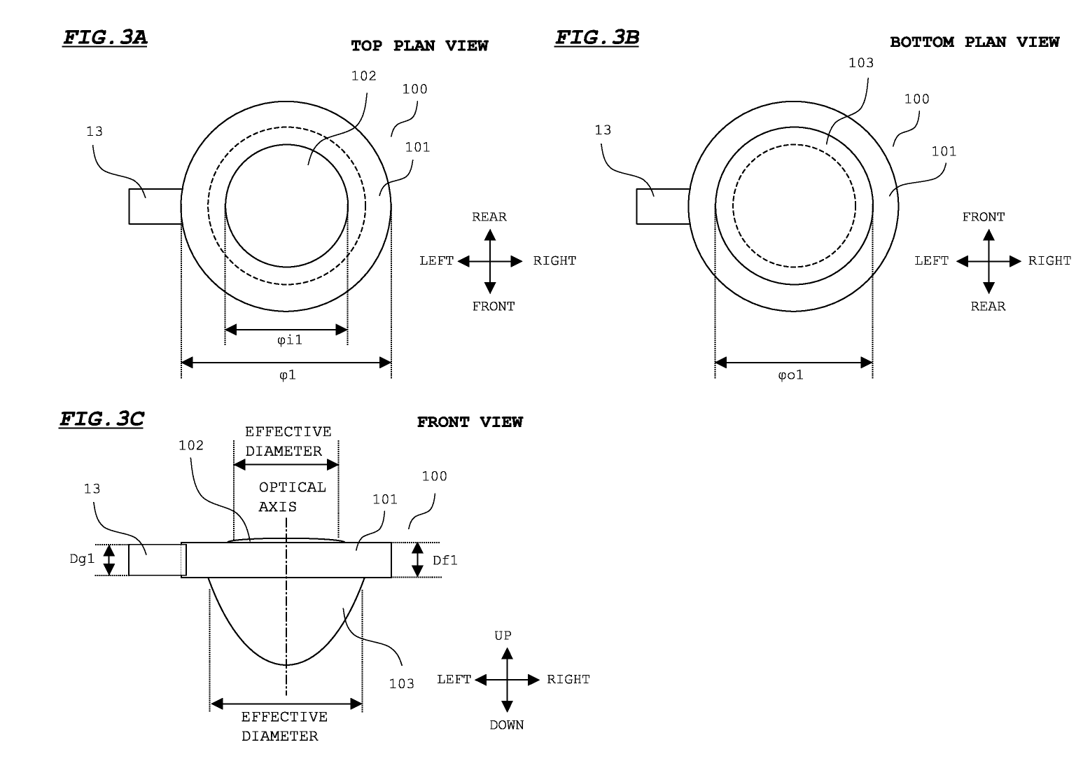

FIG. 3A is a top plan view of an objective lens 100 in the first embodiment. FIG. 3B is a bottom plan view of the objective lens 100. FIG. 3C is a front plan view of the objective lens 100. Illustration of a runner portion 12 connected to a gate portion 13 is omitted in FIGS. 3A through 3C.

Referring to FIG. 3A, the objective lens 100 has the shape of a true circle in plan view. An end portion 101 and a lens surface 102 are concentrically formed with respect to the center of the objective lens 100 in plan view, on the upper surface of the objective lens 100. The end portion 101 has a flat annular shape with a certain thickness. A diameter φi1 of the lens surface 102 is set considerably smaller than a diameter φ1 of the objective lens 100. The effective diameter of the lens surface 102 is set slightly smaller than the diameter φi1.

Referring to FIG. 3B, the end portion 101 and a lens surface 103 are concentrically formed with respect to the center of the objective lens 100 in plan view, on the lower surface of the objective lens 100. A diameter φo1 of the lens surface 103 is set larger than the diameter φi1 of the lens surface 102. The effective diameter of the lens surface 103 is set slightly smaller than the diameter φo1. Further, as shown in FIG. 3C, the optical axis of the lens surface 102 and the optical axis of the lens surface 103 are aligned with each other. The effective diameter of the lens surface 103 is set larger than the effective diameter of the lens surface 102.

Further, a flat portion on the lower surface of the end portion 101 is set narrower than a flat portion on the upper surface of the end portion 101. A thickness Df1 of the end portion 101 in up and down directions is set slightly larger than a thickness Dg1 of the gate portion 13 in up and down directions.

Further, the lens surface 102 is formed into an upwardly projecting aspherical convex portion. The lens surface 103 is formed into a downwardly projecting aspherical convex portion. The downward height of the convex portion of the lens surface 103 is set considerably larger than the upward height of the convex portion of the lens surface 102.

The gate portion 13 is connected to a left surface of the annular-shaped end portion 101 of the objective lens 100. Specifically, a connection portion between the gate portion 13 and the objective lens 100 is formed along the outer periphery of a circular portion of the lens. In the invention, a lens portion is a portion having a function capable of refracting an incident light beam. In the first embodiment, the lens portion includes the lens surface 102 and the lens surface 103.

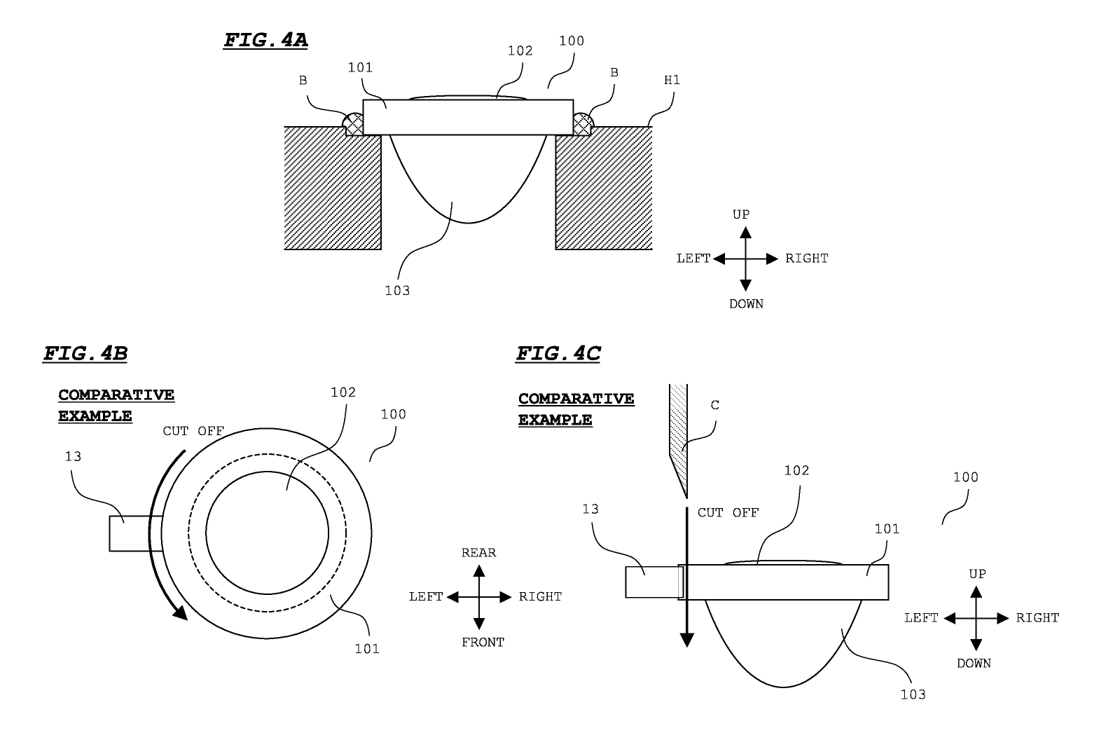

In this example, in the case where the objective lens 100 is used as an optical member, the objective lens 100 is usually mounted on a holder for use. For instance, as shown in FIG. 4A, the objective lens 100 is placed on a holder H1 from above and fixed to the holder H1 by an adhesive B. In this arrangement, if a part of the end portion 101 of the objective lens 100 is cut away, the adhesive B is likely to flow onto the lower-side lens surface 103, which may adversely affect the optical function of the objective lens 100.

In view of the above, it is desirable to form the objective lens 100 in such a manner that the outer perimeter of the objective lens 100 has a circular shape, and the area of the end portion 101 is set as small as possible. In order to meet the above requirement, for instance, as shown in a comparative example of FIG. 4B, there may be used a method for cutting off the gate portion 13 along the circumferential surface of the objective lens 100. This method, however, requires a high skill, and the cost required for cutting the objective lens 100 may increase.

As a method for easily cutting off the gate portion 13, as shown in the comparative example of FIG. 4C, there may be used a method for cutting off the end portion 101 in a direction perpendicular to the upper surface of the end portion 101, with use of a cutter C having such a cutting edge as to form a cut end into a linear shape. In this arrangement, taking into consideration of the precision of a device for driving the cutter C or the thickness of the cutter C itself, it is necessary to cut the objective lens 100 at a position slightly inward from the outer perimeter of the objective lens 100. In view of the above, in this arrangement, it is necessary to set the width of the end portion 101 wide. Further, the end portion 101 may be excessively cut depending on a cut-off operation.

In view of the above, the gate portion 13 is cut off from the objective lens 100 by the following method in the first embodiment.

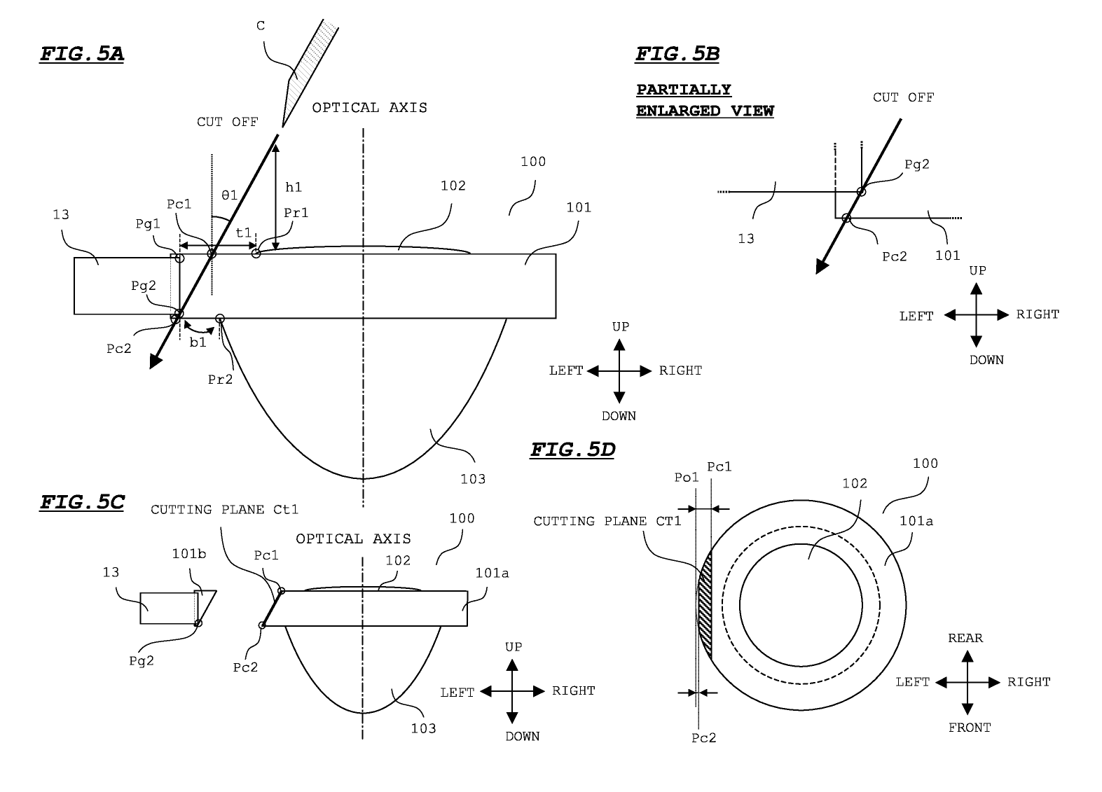

FIGS. 5A through 5D are diagrams for describing a method for cutting off the gate portion 13 from the objective lens 100 in the first embodiment.

Referring to FIG. 5A, the objective lens 100 is cut, by the cutter C, in a direction from the upper side of the objective lens 100 toward the lower side of the objective lens 100 with an inclination angle θ1 in a direction toward the optical axis of the objective lens 100 with respect to a direction perpendicular to the upper surface of the objective lens 100. In performing the cutting operation, the cutting edge of the cutter C passes Pc1 of the end portion 101 on the upper surface of the objective lens 100 and passes Pc2 of the end portion 101 on the lower surface of the objective lens 100. As shown in FIG. 5B, which is a partially enlarged view of FIG. 5A, the straight line connecting between Pc1 and Pc2 passes a contact point Pg2 between a lower end of the gate portion 13 and the end portion 101.

In this way, as shown in FIG. 5C, the gate portion 13 is completely cut off from the objective lens 100. By cutting the objective lens 100 in an oblique direction as described above, the objective lens 100 is formed into such a shape that the upper end Pc1 of a cutting plane Ct1 of the objective lens 100 is close to the optical axis, and the lower end Pc2 of the cutting plane Ct1 of the objective lens 100 is away from the optical axis. By performing the above operation, it is possible to set the area on the lower surface of the end portion 101 large after the cutting operation is performed. Accordingly, as shown in FIG. 5D, it is possible to make an area from the lower end Pc2 of the cutting plane Ct1 of the objective lens 100 to the outer perimeter of the objective lens 100, which is devoid of the end portion 101, as small as possible. For instance, as shown in the comparative example of FIG. 4C, in the case where a cutting operation is performed in such a manner that the cutting edge of the cutter C passes Pc1 and in a direction perpendicular to the upper surface of the objective lens 100, the area from Pc1 to Po1 is an area devoid of the end portion 101. This area is considerably large, as compared with the area from Pc2 to Po1, which is devoid of the end portion 101.

As described above, with a simplified operation of cutting the objective lens 100 while inclining the cutter C, it is possible to minimize the area, on the lower surface side of the objective lens 100, which is devoid of the end portion 101, while keeping the outer perimeter of the objective lens 100 in a circular shape.

In the foregoing description, the gate portion 13 is cut off in such a manner that the cutting edge of the cutter C passes Pc1 on the upper surface of the objective lens 100. A cutting operation may be performed at any position, as far as the position is included within a range t1 between the contact point Pg1 of the upper end of the gate portion 13 and the end portion 101, and an outer perimeter Pr1 of the lens surface 102, as shown in FIG. 5A, and the cutter C does not harm the lens surface 102 and the lens surface 103. In the first embodiment, the space from the lens surface 102 corresponding to the upper surface of the end portion 101 to the outer perimeter is larger than the space from the lens surface 103 corresponding to the lower surface of the end portion 101 to the outer perimeter. Accordingly, it is possible to set the range t1 wide. Thus, it is possible to specify the cutting position within the wide range t1, thereby easily cutting the objective lens 100. It is possible to extend the range t1, within which the cutting operation can be performed on the upper side of the objective lens 100, to a position corresponding to the outer perimeter of the effective diameter of the lens surface 102, as far as it is possible to cut off an area on the outer side of the effective diameter of the lens surface 102 within the outer periphery of the lens surface 102. In any of the cases, the cutting operation is performed while inclining the cutting plane with respect to the optical axis.

Further, in the foregoing description, the gate portion 13 is cut off with the inclination angle θ1 in such a manner that the cutting blade of the cutter C passes Pc2 on the lower surface of the objective lens 100. Alternatively, a cut-off operation may be performed with any angle and at any position, as far as the position is included within a range b1 between the contact point Pg2 of the lower end of the gate portion 13 and the end portion 101, and an outer perimeter Pr2 of the lens surface 102, as shown in FIG. 5A, and the cutter C does not harm the lens surface 102 and the lens surface 103. Further, it is possible to extend the range b1, within which a cutting operation can be performed on the lower side of the objective lens 100, to the outer perimeter of the effective diameter of the lens surface 103, as far as it is possible to cut off an area on the outer side of the effective diameter of the lens surface 103 within the outer periphery of the lens surface 103. In this arrangement, the end portion 101 does not surround the entire periphery of the lens surface 103, and has a substantially annular shape with apart thereof being cut away.

In the first embodiment, the cut-off operation is performed in such a manner that the lower end of the cutting plane Ct1 is close to the contact point Pg2 between the lower end of the gate portion 13 and the end portion 101. The above cutting manner is desirable, because it is possible to increase the area on the lower surface of an end portion 101a after the cutting operation is performed. Further, the cut-off operation is performed in such a manner that the cutting plane is inclined with respect to the optical axis, no matter where the lower end of the cutting plane is located.

In the case where the cutting plane Ct1 is configured to pass the contact point Pg2, for instance, it may be possible to exclude the lower end Pc2 of the cutting plane Ct1 from the lower surface of the end portion 101 by increasing the angle θ1 at which the end portion 101 is cut off. In particular, in the case where the thickness of the gate portion 13 in up and down directions is small, it may be possible to cut off the gate portion 13 in such a manner as to exclude the lower end Pc2 of the cutting plane Ct1 from the lower surface of the end portion 101 by adjusting the angle θ1 at which the end portion 101 is cut off. In such a case, it is desirable to set the angle θ1 to such a value as to exclude the lower end Pc2 of the cutting plane Ct1 from the lower surface of the end portion 101. In this arrangement, it is possible to keep the end portion 101 in an annular shape, and properly mount the objective lens 100.

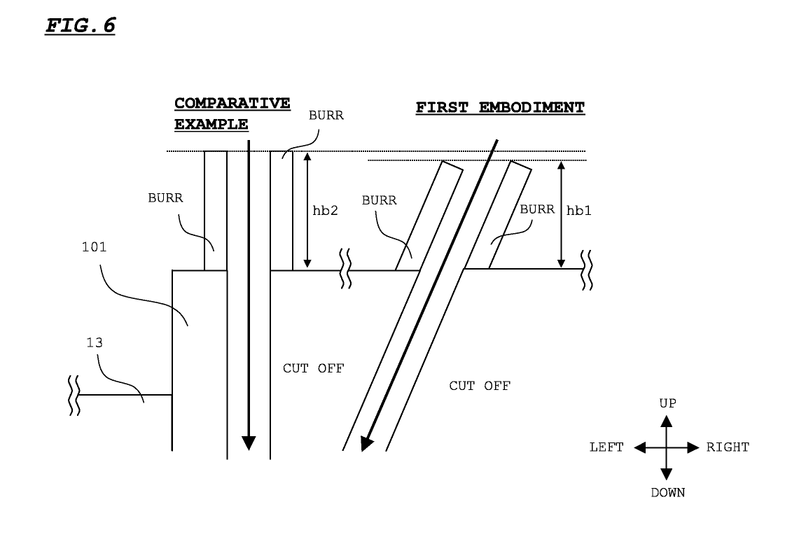

FIG. 6 is a diagram schematically showing burrs generated on the upper surface of the end portion 101 after the objective lens 100 is cut. FIG. 6 also includes a partially enlarged view of the upper surfaces of the end portion 101 and the gate portion 13 shown in FIG. 5A. Further, FIG. 6 shows a state as to how burrs are generated, in the case where a cutting operation is performed by the comparative example shown in FIG. 4C.

Referring to FIG. 6, as shown by the comparative example, in the case where a cutting operation is performed in a direction perpendicular to the upper surface of the end portion 101, burrs are generated in upward direction, and the height of the burrs reaches hb2. On the other hand, in the case where a cutting operation is performed in an oblique direction as described in the first embodiment, burrs are generated in an oblique direction, and the height hb1 of burrs in up and down directions is set lower than the height hb2.

As descried above, in the arrangement of the first embodiment, it is possible to suppress the upward height of burrs. Accordingly, as compared with the arrangement of the comparative example, the first embodiment is advantageous in forming a vacant space on the upper side of the objective lens 100. For instance, as will be described later, in the case where the objective lens 100 is loaded in an optical pickup device, the height of burrs is reduced in the first embodiment as compared with the comparative example. Accordingly, it is less likely that the burrs may be contacted with a disc surface. Thus, it is possible to suppress damage of the disc surface resulting from burrs.

It is desirable to set the angle θ1 shown in FIG. 5A as large as possible in order to reduce the height hb1 of burrs. It is most desirable to cut off the end portion 101 in a direction from the right end of the range t1 to the left end of the range b1 in FIG. 5A. This enables to maximize the angle θ1 within an allowable range, and minimize the height hb1 of burrs. However, if the cutting position on the upper surface of the end portion 101 is close to the right end of the range t1, burrs may obstruct the optical path of light passing through the objective lens 100. Accordingly, it is necessary to set the cutting position on the upper surface of the end portion 101, taking into consideration of the above point.

### Advantages of First Embodiment

The first embodiment provides the following advantages.

With a simplified operation of cutting the objective lens 100 while inclining the cutter C, it is possible to reduce the area on the lower surface side of the objective lens 100, which is devoid of the end portion 101, while keeping the outer perimeter of the objective lens 100 in a circular shape. Thus, it is possible to properly mount the objective lens 100 on a holder or a like member. Further, since it is possible to manufacture the objective lens 100 by a simplified cut-off method, it is possible to suppress the manufacturing cost of the objective lens 100.

Since the gate portion 13 is cut off while inclining the cutter C with respect to the optical axis, it is possible to reduce the radial width of the end portion 101. Thus, in the case where the diameters of the lens surface 102 and 103 are set equal to those in the comparative example, it is possible to reduce the outer diameter of the objective lens 100 as compared with the comparative example. Further, in the case where the outer diameter of the objective lens 100 is set equal to that in the comparative example, it is possible to increase the diameter of the lens surface as compared with the comparative example.

The objective lens 100 is cut in such a manner that the upper end of the cutting plane is close to the optical axis of the objective lens, and the lower end of the cutting plane is away from the optical axis of the objective lens. Accordingly, in performing a cutting operation, the cutting edge of the cutter C passes in a direction away from the lens surface 103, where the diameter is large and the height is high. Accordingly, it is possible to avoid damage of the lens surface 103 in performing a cut-off operation of the gate portion 13.

Since the diameter of the upper-side lens surface 102 is small, it is possible to set the upper end Pc1 of the cutting plane Ct1 at a position close to the optical axis. Further, since the height of the lens surface 102 is low, it is possible to set the distance h1 (see FIG. 5A) between the cutter C and the lens surface 102 large to some extent. Accordingly, it is possible to suppress damage of the lens surface 102 in performing a cut-off operation of the gate portion 13.

Since the objective lens 100 is cut in a direction from the lens surface 102 side where the effective diameter is small toward the lens surface 103 side where the effective diameter is large, it is possible to determine the cutting position within the wide range t1, thereby easily cutting the objective lens 100.

Since the objective lens 100 is cut in such a manner that the cutting blade of the cutter C passes the contact point Pg2 between the lower end of the gate portion 13 and the end portion 101, this arrangement is further advantageous in suppressing the area on the lower surface side of the objective lens 100, which is devoid of the end portion 101.

Since the height of burrs in up and down directions can be reduced, the above arrangement is advantageous in easily forming a vacant space on the upper side of the objective lens 100. Accordingly, it is possible to suppress damage of an object facing the upper surface of the objective lens 100 by burrs.

### Second Embodiment

In the first embodiment, there is described an arrangement, wherein a D-shaped portion is not formed. The second embodiment is an example, wherein the invention is applied to an arrangement in which a D-shaped portion is formed.

In the second embodiment, an objective lens 200 corresponds to a lens in the claims. Lens surfaces 202 and 203 correspond to a “lens portion” in the claims. The lens surface 202 corresponds to a “first lens surface” in the claims. The lens surface 203 corresponds to a “second lens surface” in the claims. A contact point Pd corresponds to a “connection position” in the claims. The description regarding the correspondence between the claims and the second embodiment is merely an example, and the claims are not limited by the description of the second embodiment.

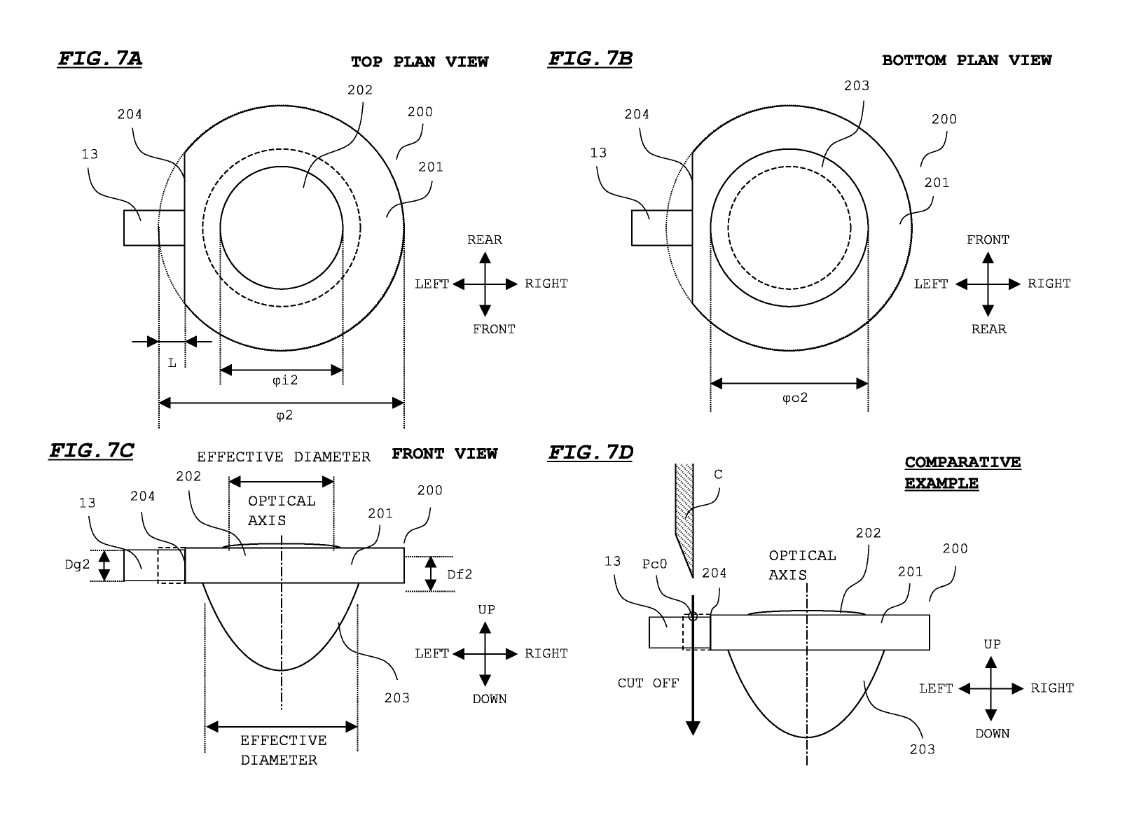

FIG. 7A is a top plan view of an objective lens 200 in the second embodiment. FIG. 7B is a bottom plan view of the objective lens 200. FIG. 7C is a front plan view of the objective lens 200. The objective lens 200 is connected to a runner portion 12 of a lens intermediate body 1 via a gate portion 13 in the same manner as the objective lens 100 in the first embodiment, and illustration of these members is omitted herein.

Referring to FIGS. 7A through 7C, the objective lens 200 has substantially the same arrangement as the objective lens 100 in the first embodiment except that the objective lens 200 is formed with a D-shaped portion 204. An end portion 201, and lens surfaces 202 and 203 respectively correspond to the end portion 101, and the lens surfaces 102 and 103 in the first embodiment. The sizes of diameters φi2 and φo2 are the same as the sizes of the diameters φi1 and φo1 in the first embodiment. Further, the effective diameters of the lens surfaces 202 and 203 are the same as the effective diameters of the lens surfaces 102 and 103 in the first embodiment.

The objective lens 200 has such a shape that a part of a true circle is cut away in plan view. The D-shaped portion 204 is formed by cutting the true circular portion of the objective lens 200 at a position rightwardly away from the left end of the objective lens 200 by a distance L along a straight line in front and rear directions. The gate portion 13 is connected to the D-shaped portion 204 in such a manner as to extend leftwardly from the D-shaped portion 204.

In the case where the D-shaped portion 204 is formed as described above, as shown by the comparative example of FIG. 7D, the gate portion 13 is usually cut off in up and down directions in the range corresponding to the distance L (see FIG. 7A) from the outline of a circle that defines the outer perimeter of the objective lens 200 to a side surface of the D-shaped portion 204. In this arrangement, the remainder of the gate portion 13 that is left after the cut-off operation is performed lies within the circle that defines the outer perimeter of the objective lens 200.

However, in the above arrangement, it is necessary to set the distance L to a relatively large value in order to allow the remainder of the gate portion 13 to lie within the circle that defines the outer perimeter of the objective lens 200. Specifically, taking into consideration of the precision of a device for driving the cutter C or the leftward/rightward thickness of the cutter C itself, it is necessary to cut off the gate portion 13 at a position Pc0 which is leftwardly away from the side surface of the D-shaped portion to some extent. As a result, the leftward projection amount of the remainder of the gate portion 13 is large to some extent. Accordingly, it is necessary to retract the side surface of the D-shaped portion 204 to a position greatly and rightwardly away from the outline of the circle so that the remainder of the gate portion 13 lies within the circle that defines the outer perimeter of the objective lens 200. As a result, it is necessary to set the distance L shown in FIG. 7A to a relatively large value.

An increase in the distance L as described above increases the radial width of the end portion 201. Accordingly, an unwanted area may be formed on the outer side of the lens surfaces 202 and 203, which may increase the cost of the objective lens 200 and obstruct miniaturization.

In the case where the D-shaped portion 204 is formed as described above, it is possible to cut off the gate portion 13 substantially by the same method as described in the first embodiment.

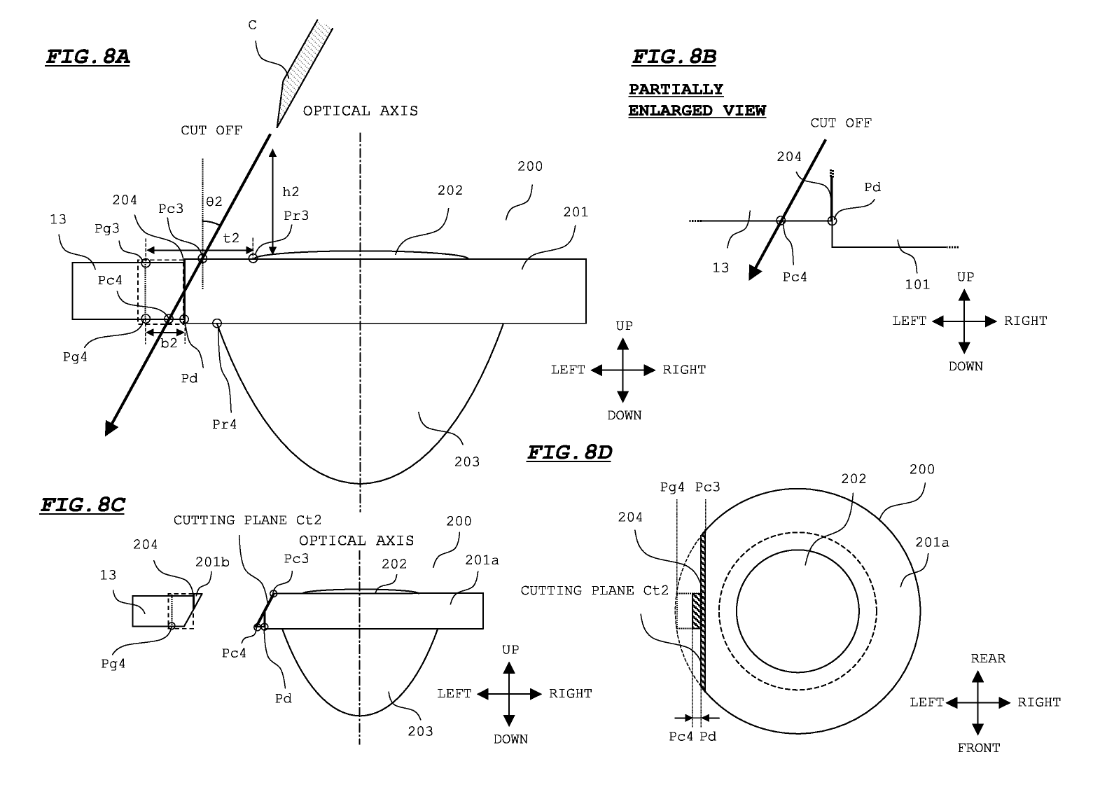

FIGS. 8A through 8D are diagrams for describing a method for cutting off the gate portion 13 from the objective lens 200 in the second embodiment.

Referring to FIG. 8A, the objective lens 200 is cut, by the cutter C, in a direction from the upper side of the objective lens 200 toward the lower side of the objective lens 200 with an inclination angle θ2 in a direction toward the optical axis of the objective lens 200 with respect to a direction perpendicular to the upper surface of the objective lens 200.

A cutting position Pc3 on the upper surface of the objective lens 200 is set in a range t2 from a contact point Pg3 between the outline of the circle that defines the outer perimeter of the objective lens 200 and the upper end of the gate portion 13, to the position corresponding to the diameter of the lens surface 202 in the same manner as in the first embodiment. It is possible to extend the range t2 to a position corresponding to the outer perimeter of the effective diameter of the lens surface 202, as far as it is possible to cut off an area on the outer side of the effective diameter of the lens surface 202 within the outer periphery of the lens surface 202.

It is desirable to set a cutting position Pc4 on the lower surface of the objective lens 200 within a range b2 from a contact point Pg4 between the outline of the circle that defines the outer perimeter of the objective lens 200 and the lower end of the gate portion 13, to the side surface of the D-shaped portion 204. Setting the range b2 as described above enables to suppress a decrease in the area on the lower surface of an end portion 201a resulting from a cut-off operation of the gate portion 13.

By setting the cutting position Pc4 on the lower surface of the objective lens 200 to a position close to a contact point Pd (see FIG. 8B, which is a partially enlarged view of FIG. 8A) between the lower end of the gate portion 13 and the D-shaped portion 204, as shown in FIG. 8D, it is possible to reduce a leftward projection amount of the remainder of the gate portion 13. Cutting off the gate portion 13 as described above enables to properly cut off the gate portion 13 merely by a simplified operation of cutting the objective lens 200 while inclining the cutter C with a certain angle, without reducing the thickness of the cutter C or without enhancing processing precision, even in the case where the distance L shown in FIG. 7A is set to a relatively small value.

Further, the second embodiment provides substantially the same advantages as the first embodiment.

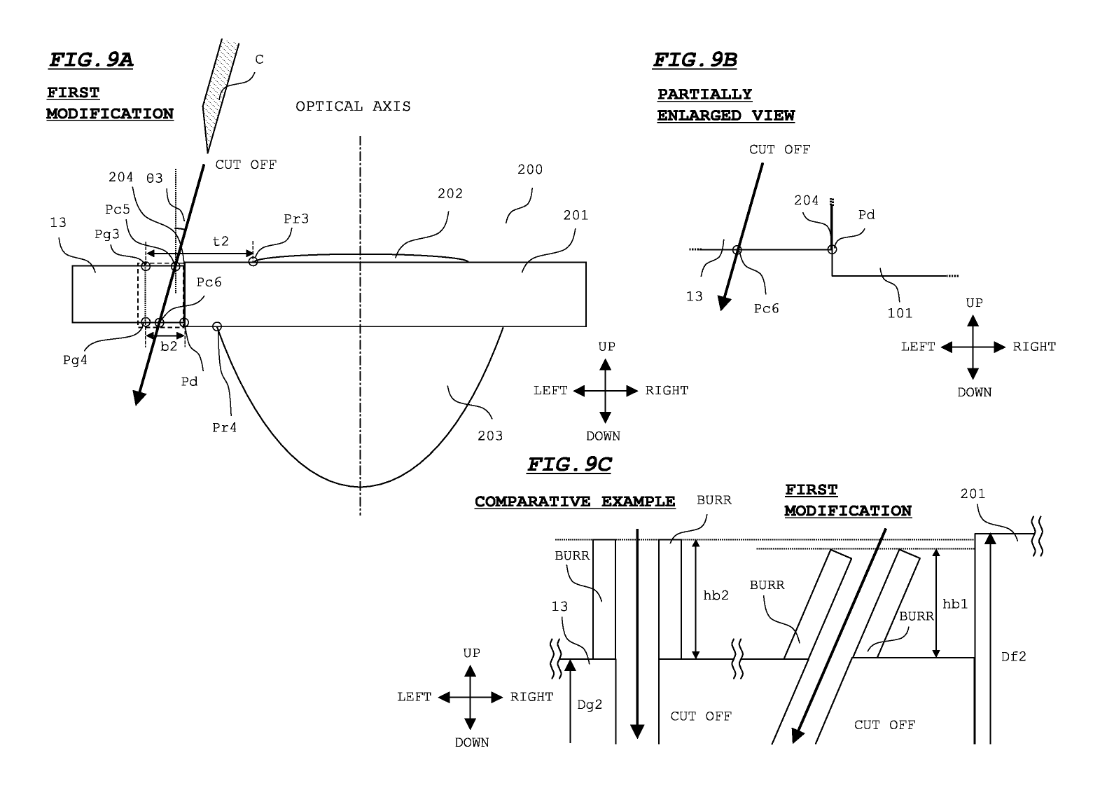

FIGS. 9A through 9C are diagrams showing a first modification, in the case where the gate portion 13 is cut off from the objective lens 200 in the second embodiment at a position other than the above.

Referring to FIG. 9A, the objective lens 200 is cut, by the cutter C, with an inclination angle θ3 in a direction toward the optical axis of the objective lens 200 with respect to a direction perpendicular to the upper surface of the objective lens 200. In performing the cutting operation, the gate portion 13 is cut off in such a manner that the cutting plane is excluded from the upper surface and the lower surface of the end portion 201.

In the first modification, as shown in FIG. 9C, since burrs are generated in an oblique direction with respect to the gate portion 13, it is possible to reduce the height hb1 of burrs, as compared with the arrangement of the comparative example, in which the gate portion 13 is cut off in up and down directions. Thus, it is possible to set a thickness Dg2 of the gate portion 13 to a large value as compared with the arrangement of the comparative example. In this arrangement, it is easy to inject resin through a die groove for injection molding for forming the objective lens 200. This is advantageous in smoothly performing injection molding.

<Optical Pickup Device>

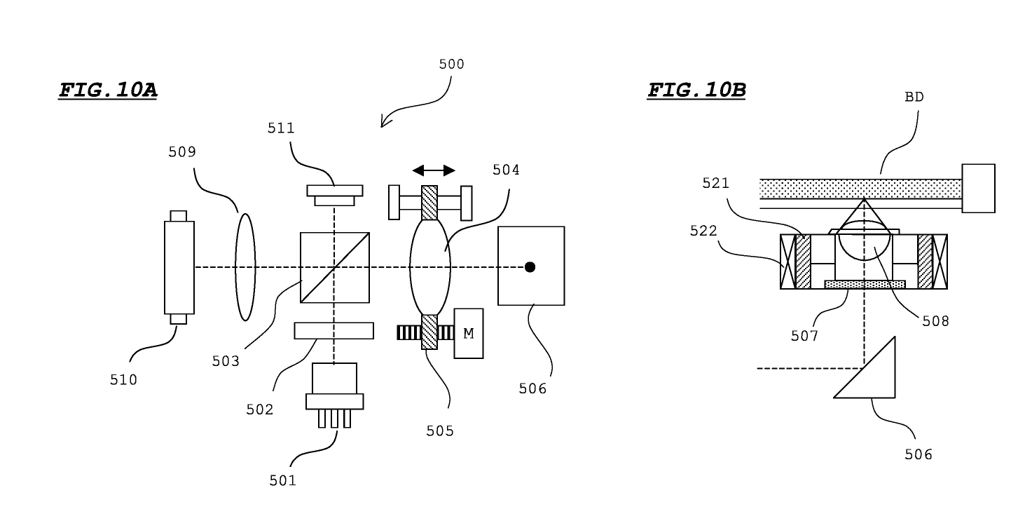

FIGS. 10A and 10B show an example of an arrangement of an optical system (optical system for BD) in an optical pickup device 500 loaded with the objective lens 100 or the objective lens 200, which is designed based on the first embodiment or the second embodiment.

In this embodiment, an objective lens 508 corresponds to a “lens” in the claims. An optical pickup device 500 corresponds to an “optical device” in the claims. The description regarding the correspondence between the claims and the embodiment is merely an example, and the claims are not limited by the description of the embodiment.

The optical system for BD is constituted of a semiconductor laser 501, a diffraction grating 502, a polarized beam splitter 503, a collimator lens 504, a collimator lens actuator 505, a rise-up mirror 506, a quarter wave plate 507, an objective lens 508, an anamorphic lens 509, a photodetector 510, and an FMD (Front Monitor Diode) 511.

The semiconductor laser 501 outputs blue laser light of or about 400 nm wavelength. The diffraction grating 502 divides the laser light emitted from the semiconductor laser 501 into a main beam and two sub beams. The polarized beam splitter 503 reflects and transmits the laser light entered from the diffraction grating 502 side. The semiconductor laser 501 is disposed at such a position that the polarization direction of emitted laser light is slightly displaced from the polarization direction of S-polarized light with respect to the polarized beam splitter 503. In this arrangement, for instance, 95% of laser light transmitted through the diffraction grating 502 is reflected on the polarized beam splitter 503, and 5% as the remainder of laser light transmitted through the diffraction grating 502 is transmitted through the polarized beam splitter 503.

The collimator lens 504 converts the laser light reflected on the polarized beam splitter 503 into parallel light. The collimator lens actuator 505 drives the collimator lens 504 in the optical axis direction of laser light. The collimator lens 504 and the collimator lens actuator 505 function as aberration correcting means.

The rise-up mirror 506 reflects the laser light entered through the collimator lens 504 in a direction toward the objective lens 508. The quarter wave plate 507 converts laser light reflected on the rise-up mirror 506 into circularly polarized light, and converts reflected light from a disc (BD) into a linearly polarized light whose polarization direction is orthogonal to the polarization direction of laser light toward the disc. By performing the above operation, laser light reflected on a disc is transmitted through the polarized beam splitter 503, and guided to the photodetector 510.

The objective lens 508 is formed by injection molding, with use of a resin material. The objective lens 508 is formed by cutting off a gate portion in an oblique direction in the same manner as the objective lens 100 in the first embodiment and the objective lens 200 in the second embodiment. The cutting plane is configured in such a manner that the disc (BD) side surface thereof is close to the optical axis and the light source side surface thereof is away from the optical axis. Further, the objective lens 508 is mounted in such a manner that the light source side surface of the objective lens 508 is placed on a holder 521. The holder 521 is driven in a focus direction and in a tracking direction by an objective lens actuator 522.

The anamorphic lens 509 converges laser light reflected on the disc onto the photodetector 510. The photodetector 510 has a sensor pattern for deriving a reproduction RF signal, a focus error signal and a tracking error signal from an intensity distribution of received laser light. In this embodiment, an astigmatism method is employed as a focus error signal generating method, and a DPP (Differential Push Pull) method is employed as a tracking error signal generating method. The photodetector 510 has a sensor pattern for deriving a focus error signal and a tracking error signal in accordance with these methods.

The FMD 511 receives laser light transmitted through the polarized beam splitter 503, and outputs a signal in accordance with a received light amount. A signal from the FMD 511 is used for power control of the semiconductor laser 501.

The optical pickup device having the aforementioned construction example is advantageous in reducing an area on the surface of the objective lens 508 to be contacted with the holder 521, which is devoid of the end portion. Accordingly, it is possible to properly mount the objective lens 508 on the holder 521.

Further, in the step of adhesively mounting the objective lens 508 on the holder 521, it is less likely that the adhesive may flow onto the lens surface of the objective lens 508 corresponding to the light source side. Accordingly, it is possible to properly read and write with respect to a disc (BD), without impairing the optical function of the objective lens 508.

Further, since it is possible to manufacture the objective lens 508 with an inexpensive cost by a simplified method for cutting off a gate portion, it is possible to reduce the overall cost of the optical pickup device.

Further, burrs of the objective lens 508 are generated in an oblique direction. Accordingly, even in the case where the objective lens 508 is driven to a position close to a disc (BD) by the objective lens actuator 522, it is possible to suppress damage of the disc (BD). In the above arrangement, the optical pickup device (optical device) is provided with the lens having the shape as described in the first embodiment or the second embodiment, and a control system (constituted of the collimator lens actuator 505, the objective lens actuator 522 and the photodetector 510) which controls an image to be formed by the arrangement configured to pass a light beam through the lens.

<Camera Module>

In this embodiment, objective lenses 621a through 621d correspond to a “lens” in the claims. A camera module 600 corresponds to an “optical device” in the claims. The description regarding the correspondence between the claims and the embodiment is merely an example, and the claims are not limited by the description of the embodiment.

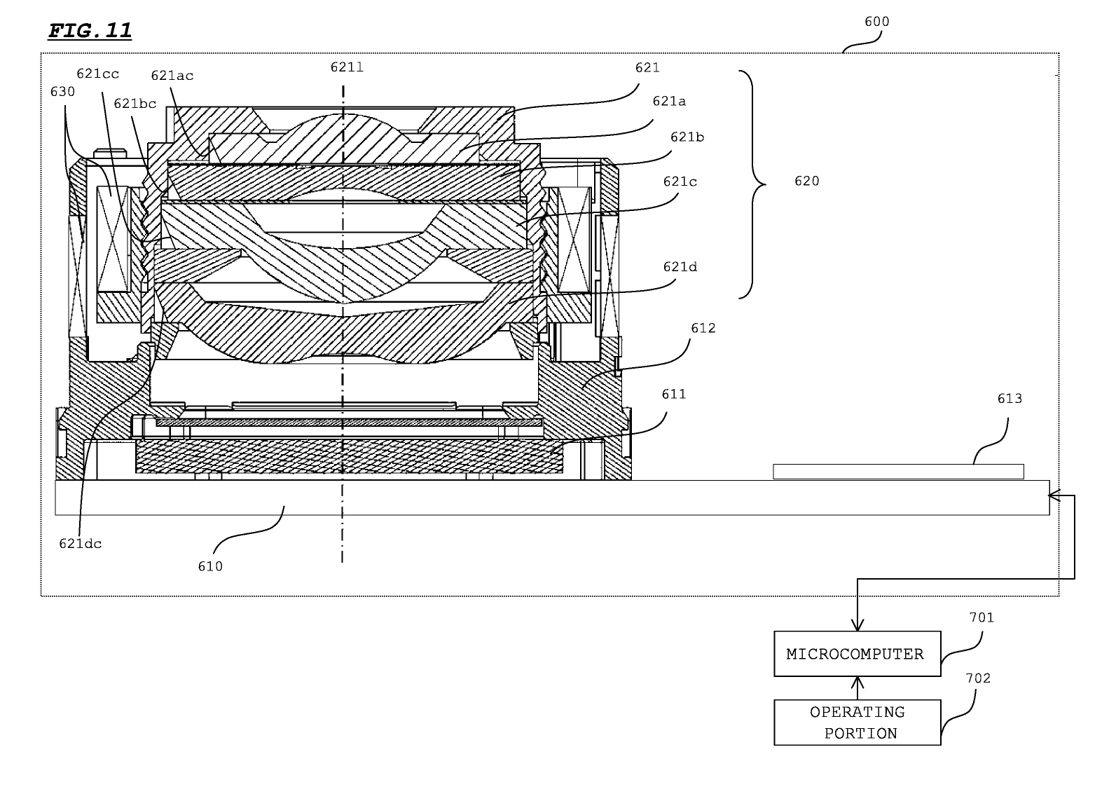

FIG. 11 is a cross-sectional view showing a manner as to how the lens having the shape as described in the first embodiment is used in a camera module (optical device) which is loaded in a photographing device such as a mobile phone.

In the camera module 600, an image sensor 611, a base 612 and a DSP 613 are loaded on a printed circuit board 610. A lens module 620 is provided with a tubular-shaped lens barrel 621 having a bottom portion; and four resin lenses 621a, 621b, 621c and 621d which are housed in the lens barrel 621. The four lenses 621a, 621b, 621c and 621d respectively have slopes (cutting planes) 621ac, 621bc, 621cc and 621dc which are inclined with respect to corresponding optical axes 6211. The lenses 621a, 621b, 621c and 621d are pressingly inserted in the lens barrel 621.

The four lenses 621a, 621b, 621c and 621d are formed by injection molding, with use of a resin material. As described in the first embodiment and the second embodiment, the lenses 621a, 621b, 621c and 621d are formed by cutting off a gate portion in an oblique direction.

The lens barrel 621 is movable along the optical axis by a pair of actuators 630. Further, plural pairs of the actuators 630 are provided, so that the actuator pairs 630 can be used as a zoom actuator and a focus actuator.

The camera module 600 forms an image of light entered to the lens module 620 onto the image sensor 611 by the lens module 620, and converts the light image into an electrical signal by the image sensor 611. The electrical signal is processed by the DSP 613. The camera module 600 is communicatively connected to a microcomputer 701 which is incorporated in a device body such as a mobile phone. The microcomputer 701 is connected to an operating portion 702 formed on the device body, and is operable to receive an input signal from the operating portion 702. In the case where an input signal for executing a photographing operation is inputted from the operating portion 702 by user's manipulation of the operating portion 702, the microcomputer 701 receives the input signal from the operating portion 702, whereby the microcomputer 701 acquires information on the image formed on the image sensor 611. Thereafter, the microcomputer 701 calculates e.g. a shutter speed required for a photographing operation, based on the acquired information. Then, the microcomputer 701 executes an image photographing operation at e.g. the calculated shutter speed, whereby an image of a subject is acquired.

In the above arrangement, the camera module (optical device) is provided with the lens having the shape as described in the first embodiment, and a control system (actuator) which controls an image to be formed by a light beam passing through the lens.

The camera module having the aforementioned construction example provides substantially the same advantage as the construction example of the optical pickup device.

The embodiments of the invention have been described as above. The invention is not limited to the foregoing embodiments, and the embodiments of the invention may be modified in various ways other than the above.

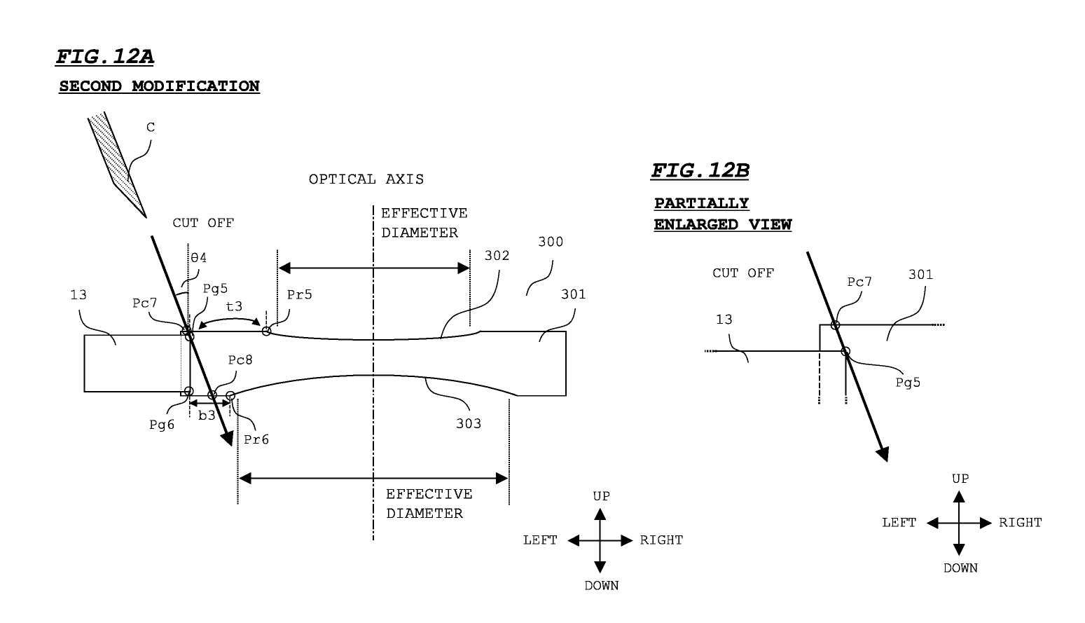

For instance, in the first embodiment and in the second embodiment, the biconvex objective lenses 100 and 200 whose lens surfaces are convex upwardly and downwardly are used. Alternatively, as shown in a second modification of FIGS. 12A and 12B, the invention may be applied to a biconcave lens 300. In this modification, there is no likelihood that the lens surfaces may be damaged. Accordingly, the lens may be cut in such a manner that a lower portion of the lens in the cutting direction is close to the optical axis of the lens surface.

In the second modification, lens surfaces 302 and 303 correspond to a “lens portion” in the claims. The description regarding the correspondence between the claims and the second modification is merely an example, and the claims are not limited by the description of the second modification.

FIG. 12A is a diagram for describing a method for cutting off a gate portion 13 from the lens 300 in the second modification.

Referring to FIG. 12A, the lens 300 has an annular-shaped end portion 301, a concave lens surface 302 having a small effective diameter on an upper surface of the lens 300, and a concave lens surface 303 having a large effective diameter on a lower surface of the lens 300. A connection portion between the gate portion 13 and the lens 300 is formed along the outer perimeter of a circular portion of the lens.

The lens 300 is cut, by the cutter C, in a direction from the upper side of the lens 300 toward the lower side of the lens 300 with an inclination angle θ4 in a direction away from the optical axis of the lens 300 with respect to a direction perpendicular to the upper surface of the lens 300. In performing the cutting operation, the cutting edge of the cutter C passes Pc7 of the end portion 301 on the upper surface of the lens 300 and passes Pc8 of the end portion 301 on the lower surface of the lens 300. As shown in FIG. 12B, which is a partially enlarged view of FIG. 12A, the straight line connecting between Pc7 and Pc8 passes a contact point Pg5 between an upper end of the gate portion 13 and the end portion 301.

In the above arrangement, similarly to the first embodiment, it is possible to reduce an area on the lower surface side of the lens 300, which is devoid of the end portion 301, while keeping the outer perimeter of the lens 300 in a circular shape, with a simplified operation of cutting the lens 300 while inclining the cutter C with a certain angle.

In the second modification, similarly to the first embodiment, a cut-off operation may be performed at any position, as far as the position is include within a range t3 between the contact point Pg5 of the upper end of the gate portion 13 and the end portion 301, and an outer perimeter Pr5 of the lens surface 302, as shown in FIG. 12A, and the cutter C does not harm the lens surface 302 and the lens surface 303.

Further alternatively, a cut-off operation may be performed with any angle and at any position, as far as the position is included within a range between a contact point Pg6 of the lower end of the gate portion 13 and the end portion 301, and perimeter Pr6 of the lens surface 303, and the cutter C does not harm the lens surface 302 and the lens surface 303, or an area within the effective diameters of the lens surfaces 302 and 303.

Further alternatively, it is possible to cut the lens 300 in such a manner that the upper end of the cutting plane is close to the optical axis, and the lower end of the cutting plane is away from the optical axis, as well as in the first embodiment and the second embodiment.

In the second modification, it is desirable to cut the lens 300 in such a manner that the upper end or the lower end of the cutting plane is close to either one of the contact point Pg5 or the contact point Pg6 between the gate portion 13 and the end portion 301.

Further alternatively, the invention may be applied to any lens, as far as the lens is manufactured by cutting off a gate portion from a lens intermediate member to be formed by injection molding, such as a meniscus lens whose both surfaces are curved in the same direction, a convex lens having a convex surface convex to one side, or a concave lens having a concave surface concave to one side, in addition to the biconvex lenses described in the first and second embodiments, and the biconcave lens described in the second modification.

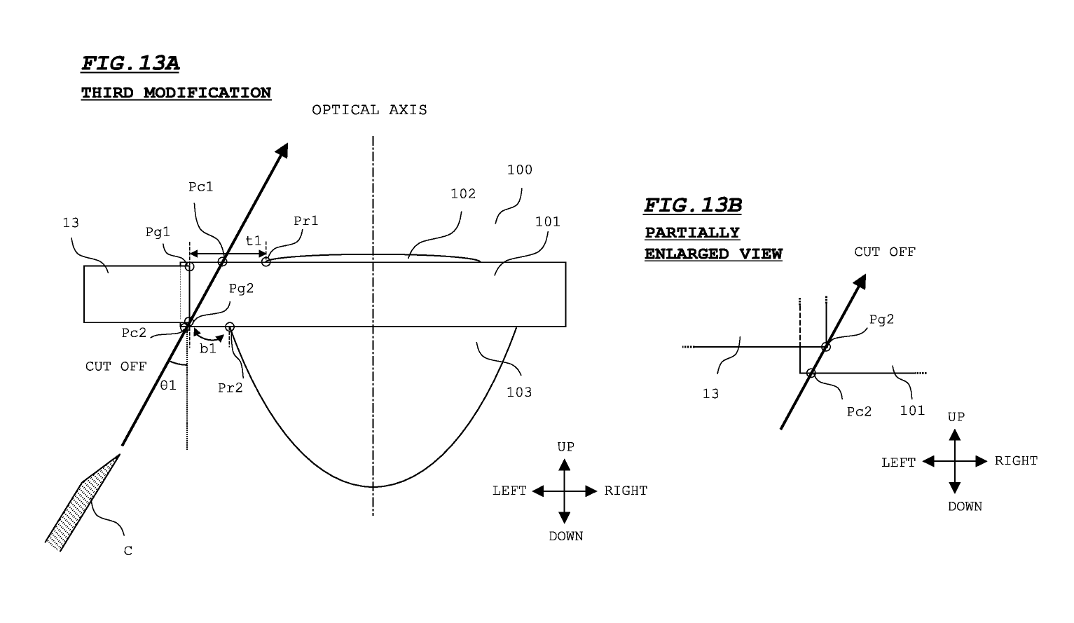

Further, in the first embodiment, the objective lens 100 is cut in a direction from the upper side of the lens toward the lower side of the lens. Alternatively, as shown in a third modification of FIGS. 13A and 13B, it is possible to cut an objective lens 100 in a direction from the lower side of the lens toward the upper side of the lens.

FIGS. 13A and 13B are diagrams for describing a method for cutting off a gate portion 13 from the objective lens 100 in the third modification. FIGS. 13A and 13B show that the lens 100 is cut at the same cutting position as shown in FIG. 5A, and the elements in FIGS. 13A and 13B corresponding to the elements in FIG. 5A are indicated with the same reference signs as those shown in FIG. 5A.

In the above modification, the upper portion of the lens 100 in the cutting direction is cut in such a manner as to come close to a lens surface 102. Accordingly, in the case where the height of the convex portion of the lens surface 102 is high, the lens surface 102 is likely to be damaged by the cutter C. However, as shown in FIGS. 13A and 13B, since the height of the convex portion of the lens surface 102 is formed to be very low in the third modification, the cutting operation hardly affects the lens surface 102.

The third modification provides substantially the same advantages as the first embodiment. Further, in the third modification, it is possible to alter the cutting position and the cutting angle, as necessary, as well as in the first embodiment.

Further, the invention is applied to an objective lens for BD in the embodiment of the optical pickup device. Alternatively, the invention may be applied to an objective lens for another purpose of use.

Further, the arrangement of the optical pickup device is not limited to the one shown in FIGS. 10A and 10B. It is possible to apply the invention to an optical pickup device compatible with two or more types of optical discs among CD, DVD and BD. Further, it is possible to apply the invention to an optical pickup device for irradiating laser light onto a magneto-optical disc, and to an objective lens to be loaded in the optical pickup device.

Further, it is possible to apply the inventive objective lens to any product, in addition to an optical pickup device and a camera module such as a mobile phone, as far as the product is loadable with a lens. Furthermore, it is possible to apply the invention to a lens other than an objective lens. In addition, the end portion is not limited to a flat portion, but a portion having a concave or convex shape such as a step portion may be included.

The embodiments of the invention may be changed or modified in various ways as necessary, as far as such changes and modifications do not depart from the scope of the claims of the invention hereinafter defined.

What is claimed is:

1. A lens manufacturing method for manufacturing a lens by injection molding, the lens including a lens portion having a circular shape, and an end portion formed on a periphery of the lens portion, the method comprising:
a cutting-off step of cutting off a gate portion from a lens intermediate body, the gate portion corresponding to a resin injection channel and being formed on a side surface of the end portion,
the cutting-off step including a step of removing the gate portion in such a manner that a cutting plane is inclined with respect to an optical axis of the lens portion.

2. The lens manufacturing method according to claim 1, wherein
the lens intermediate body has a first lens surface on one side thereof with respect to a direction of the optical axis, and a second lens surface on the other side thereof with respect to the direction of the optical axis, an effective diameter of the first lens surface being set smaller than an effective diameter of the second lens surface,
in the cutting-off step, the gate portion is cut off in such a manner that an upper end of the cutting plane is close to the optical axis and that a lower end of the cutting plane is away from the optical axis, and
the upper end of the cutting plane is located on the one side, and the lower end of the cutting plane is located on the other side.

3. The lens manufacturing method according to claim 2, wherein
in the cutting-off step, the gate portion is cut off in such a manner that the lower end of the cutting plane is close to a connection position between the gate portion and the end portion.

4. A lens to be formed by cutting off a gate portion from a lens intermediate body formed by injection molding, the gate portion being formed on a side surface of an end portion, the lens comprising:
a lens portion having a circular shape; and
the end portion formed on a periphery of the lens portion, wherein
a cutting plane along which the gate portion is cut off is configured to incline with respect to an optical axis of the lens portion.

5. The lens according to claim 4, wherein
the lens portion has a first lens surface on one side thereof with respect to a direction of the optical axis, and a second lens surface on the other side thereof with respect to the direction of the optical axis, an effective diameter of the first lens surface being set smaller than an effective diameter of the second lens surface,
the cutting plane is configured in such a manner that an upper end of the cutting plane is close to the optical axis and that a lower end of the cutting plane is away from the optical axis, and
the upper end of the cutting plane is located on the one side, and the lower end of the cutting plane is located on the other side.

6. The lens according to claim 5, wherein
the cutting plane is configured in such a manner that the lower end of the cutting plane is close to a connection position between the gate portion and the end portion.

7. An optical device, comprising:
a lens to be formed by cutting off a gate portion from a lens intermediate body formed by injection molding, the gate portion being formed on a side surface of an end portion; and
a control system which controls an image to be formed by a light beam passing through the lens,
the lens including:
a lens portion having a circular shape; and
the end portion formed on a periphery of the lens portion, wherein
a cutting plane along which the gate portion is cut off is configured to incline with respect to an optical axis of the lens portion.

8. The optical device according to claim 7, wherein
the lens portion has a first lens surface on one side thereof with respect to a direction of the optical axis, and a second lens surface on the other side thereof with respect to the direction of the optical axis, an effective diameter of the first lens surface being set smaller than an effective diameter of the second lens surface,
the cutting plane is configured in such a manner that an upper end of the cutting plane is close to the optical axis and that a lower end of the cutting plane is away from the optical axis, and
the upper end of the cutting plane is located on the one side, and the lower end of the cutting plane is located on the other side.

9. The optical device according to claim 8, wherein
the cutting plane is configured in such a manner that the lower end of the cutting plane is close to a connection position between the gate portion and the end portion.
